(19) United States
(12) Patent Application Publication
(10) Pub. No.: US 2010/0276942 A1
(43) Pub. Date: Nov. 4, 2010

(54) Electrical Power Generation From Fluid Flow

(76) Inventors: Raymond John Hicks, Powys (GB); Frank Cunliffe, Gloucestershire (GB)

Correspondence Address: KING & SCHICKLI, PLLC, 247 NORTH BROADWAY, LEXINGTON, KY, 40507, US

(21) Appl. No.: 12/670,268

(22) PCT Filed: Jul. 31, 2008
(86) PCT No.: PCT/IB08/02484

§ 371 Date: Jun. 21, 2010

(30) Foreign Application Priority Data
Jul. 30, 2007 (GB) 0714777.0

(51) Int. Cl. F16H 48/02; F03B 13/00; H02K 7/116

(52) U.S. Cl. 290/1 C; 475/150; 290/54

(57) ABSTRACT

A rotatable drive mechanism is disclosed for a power generating apparatus 5. The drive mechanism provides a link between an electrical generator 20 and a turbine 10, for example a wind or water turbine. In use the turbine 10 rotates at variable speed and the rotatable drive mechanism produces a fixed speed output to generator 20. The drive mechanism includes a differential gearbox 16 which has two output shafts; one driving the generator 20 via shaft 26 and another driving an electric machine 30 via gearing 18. In use, a varying reaction torque provided by the electric machine 30 can be used to control the torque and speed at the output shaft 26. The input torque from the turbine 10 is measured at a reaction point of the gearbox 16 and this measurement is used to alter the reaction torque provided by the electric machine 30. In use the electric machine 30 is operated so that the inertia in the gearbox 18 and the inertia of the electric machine 30 is negated, to provide an almost instantaneous change in the reaction torque and thereby to more effectively control the speed of the output shaft 26.

The present invention relates to the control of the generation of electrical power from fluid flow driven rotatable turbomachines such as wind or water turbines.

Whilst power generation from turbines etc driven by wind or water kinetic energy is generally known, problems in providing a reasonably constant output where fluctuations in input occur, have proved difficult to overcome. In particular, where alternating current electrical output has to be provided to feed a power grid system, varying torques applied to generators cause problems because, for many alternating current generators, such as a synchronous generator, the output frequency changes in proportion to their driven torque or speed. Controlling the driven speed of a generator is difficult without loss of efficiency for example in wind turbines, turbine blade pitch control can be used to, effectively, spill wind power during wind gusts to keep the torque applied to a generator reasonably constant. Conventionally, it is possible to rectify the power output and then produce an alternating current if required, so input frequency is not so important. Mechanically variable speed transmissions are an alternative method of operation, but these techniques result in losses.

Published document US 2007/0007769 shows a method of mechanically regulating the speed of a generator, by selectively adjusting reaction torque introduced into a gear train, via a hydrodynamic coupling. The document uses a planetary gear arrangement for introducing the reaction torque and for variably adjusting the speed of an output shaft during full load conditions. However this system is not efficient because at high speeds energy is lost from regulation of the output speed, as a result of employing a full power rated hydrodynamic coupling to provide the variable ratio.

WO96/30669 shows a planetary variable ratio gearbox which is used to control the output for a wind turbine power generator. The gearbox employs a stepper motor which can be powered to operate in forward or reverse directions.

EP 0120654 shows a speed controlling gearbox which uses a hydraulic or electric machine as a motor or as a generator to control the reaction leg of a differential variable ratio gearbox. However, when a small electric machine is used, to save on costs and weight, it is necessary to have speed decreasing gearbox to increase the torque of the electric machine. This in turn has the effect of increasing the effective inertia of the electric machine and that inertia causes problems when reasonably quick changes in the reaction torque at the variable ratio gearbox are required.

A synchronous generator will move into phase with the alternating current of an electrical grid and will be pulled or pushed into phase to some degree by the grid. However, to avoid inefficiencies it is better to keep the generator correctly in phase by altering its input torque.

Embodiments of the invention address the problems discussed above. According to a first aspect a present invention provides a rotatable drive mechanism for driving an electrical generator, which mechanism provides a substantially constant speed rotational output for driving the generator from a variable speed rotatable input, the mechanism including a variable speed input, geared differential transmission for receiving power from the variable speed input, the differential transmission having two power sharing paths, a first of the paths in rotational communication with an output for driving the generator and a second of the paths in rotational communication with an electric machine operable to provide a variable reaction torque in the second path, the mechanism including a torque monitor for monitoring dynamic torque at the input and a controller for altering the reaction torque in the second path in response to changes in the monitored torque, by means of operating the electric machine as a motor or a generator, and thereby permitting the substantially constant speed rotation of the output, characterised in that the monitor monitors the dynamic torque at the input and the controller operates the electric machine to negate at least some of the inertia of the electric machine and/or of the second of the paths.

In an embodiment the input includes a shaft and a step-up gearbox for increasing the rotational speed delivered to the geared transmission

Preferably, said dynamic torque monitor monitors the substantially stationary reaction torque of the step-up gearbox.

Conveniently, said differential transmission comprises a planetary gear arrangement having a planet gear carrier for being driven by the input, a sun wheel which forms part of the first power path and a ring gear which forms part of the second power path.

In one embodiment, when the input speed is below a predetermined value the electric machine is operable as a motor and provides a variable reaction torque in the second path such that a driving torque is provided to the gear transmission via the second power path and in so doing maintains the rotational speed of the first power path substantially at a predetermined speed.

Preferably, when the input speed is above the predetermined value the electric machine operable as a generator and provides a further variable reaction torque and accepts power from the gear transmission via the second power path and in so doing maintains the rotational speed of the first power path substantially at the predetermined speed.

Conveniently, the second power path includes a further gearing for changing the rotational speed of the second power path.

In one embodiment the first or second power path includes a clutch or brake for disengaging or braking the respective path when rotation of the is rotor is inhibited but the generator is still in motion.

Preferably, the electric machine is a switched reluctance machine (SRM).

More preferably, the angular position of the SRM is used, in part, to control the reaction torque.

According to a second aspect the invention provides a method of controlling the rotational speed of a generator drive mechanism to provide a substantially constant rotational speed for the generator resulting from a variable speed input, the method employing a mechanism which provides a substantially constant speed rotational output for driving the generator from a variable torque rotatable input, the mechanism including a variable speed input, geared differential transmission for receiving power from the variable torque input, the differential transmission having two power sharing paths, a first of the paths in rotational communication with an output for driving the generator and a second of the paths in rotational communication with an electric machine operable to provide a variable reaction torque in the second path, the method including the following steps, to be performed in any suitable order, of:

a) monitoring the dynamic torque of the input;
b) controlling the reaction torque in the second path in response to the monitored dynamic input torque, by means of operating the electric machine as a motor or a generator, and thereby permitting the substantially constant speed rotation of the output; and the method being characterised by the step of:
c) operating the electric machine to substantially negate the effects of inertia in the second path and/or in the electric machine.

Preferably, the monitored dynamic input torque is the reaction torque of the geared differential transmission.

Conveniently, the method includes the further steps of:

d) in addition to step a), measuring the input speed and generator load; and
e) controlling the reaction torque in the second path in response to the input speed and generator load, as well as in response to the monitored input torque, by means of operating the electric machine as a motor or a generator.

More conveniently, the method includes the further steps of:

f) operating the electric machine as a motor, at a first predetermined input speed range; and
g) operating the electric machine as a generator at a second predetermined input speed range which second range is higher than the first range.

According to a third aspect, the invention provides a rotatable drive mechanism for driving an electrical generator, which mechanism provides a substantially constant speed rotational output for driving the generator from a variable speed rotatable input, the mechanism including a variable speed input, geared differential transmission for receiving power from the variable speed input, the differential transmission having two power sharing paths, a first of the paths in rotational communication with an output for driving the generator and a second of the paths in rotational communication with an electric machine operable to provide a variable reaction torque in the second path, the mechanism including a torque monitor for monitoring dynamic torque at the input and a controller for altering the reaction torque in the second path in response to changes in the monitored torque, by means of operating the electric machine as a motor or a generator, and thereby permitting the substantially constant speed rotation of the output, characterised in that the dynamic input torque is monitored by means of measuring the stationary reaction torque of the geared differential transmission.

The invention extends to a wind or water driven turbine, having a rotatable drive mechanism as described above or having a drive mechanism operable according to the method described above.

According to a further aspect, the invention provides a wind or water driven turbine including a variable speed wind or water drivable rotor, a generator, and a differential gearbox providing rotary communication between the rotor and the generator, the generator being drivable, via the gearbox, at substantially constant speed by the variable speed rotor, the gearbox providing a variable torque reacting against the rotor torque for allowing said substantially constant generator speed and for allowing said rotor to increase or decrease in speed with increased or decreased wind or water speed characterised in that the dynamic input torque applied to the gearbox by the rotor at a reaction point of the gearbox is measured to provide said variable torque reacting against the rotor.18. A wind or water turbine as claimed in claim 17 wherein the variable reaction torque is providable by a further generator having further rotary communication with the gearbox, the further generator being operable as a further generator or as a motor, and being further operable to substantially negate its own inertia and/or the inertia of said further rotary communication.

Preferably, the further generator is a switched reluctance machine.

One embodiment of the invention is described below by way of example only, with reference to the drawings wherein:

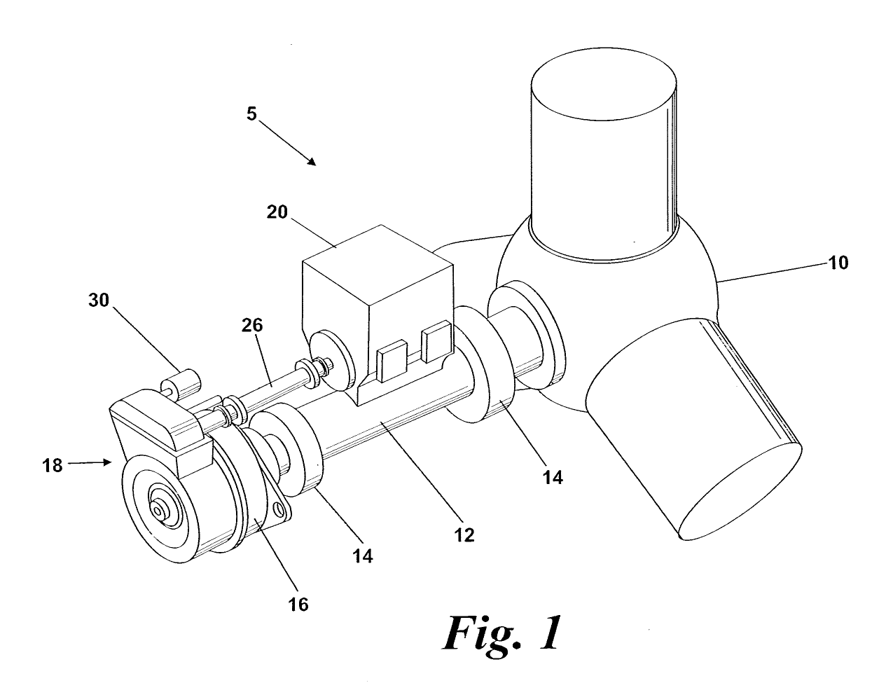

FIG. 1 shows a pictorial representation of a system for generating power from a fluid flow;

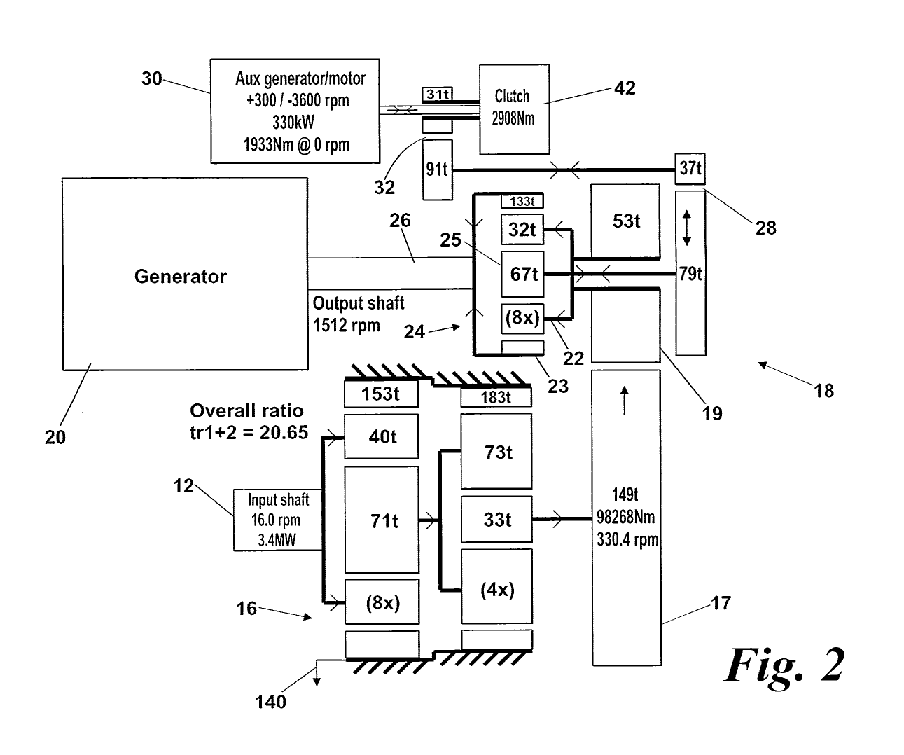

FIG. 2 shows a schematic representation of a transmission system for the power generating system of FIG. 1;

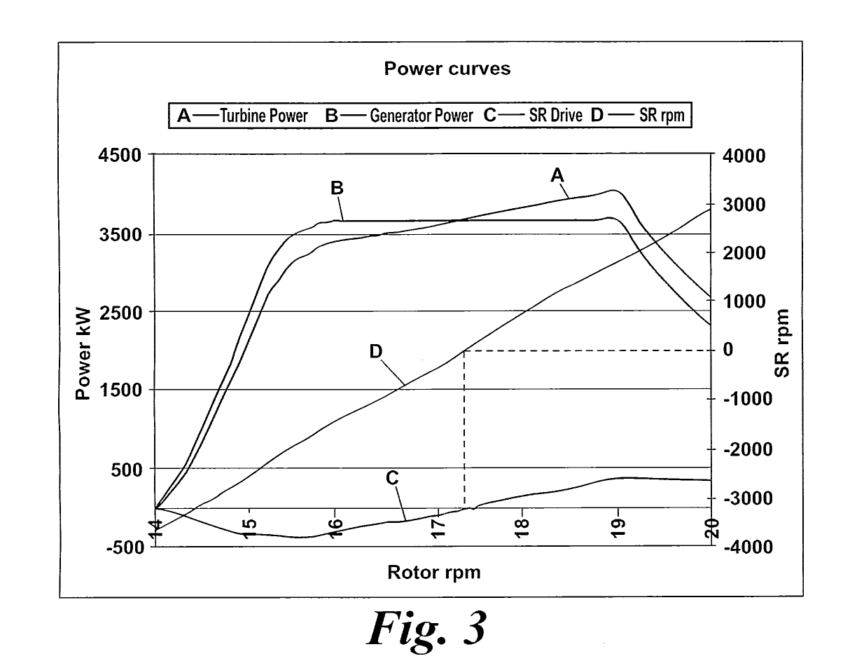

FIG. 3 is a graph illustrating power output and motor/generator speed against rotor speed; and

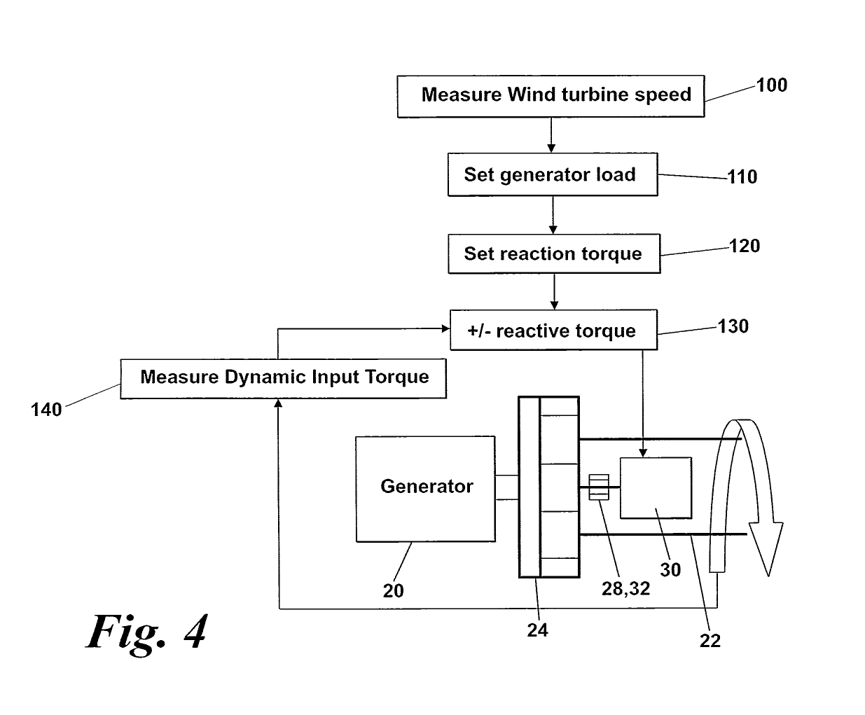

FIG. 4 is a flow diagram illustrating the method of control of the system.

Referring to FIG. 1, a power generating apparatus 5 is shown which includes a wind turbine rotor 10 supported on a shaft 12. Main bearings 14 are illustrated, but the housing of the bearings 14 is not shown, for clarity. Shaft 12 acts as an input shaft to feed a planetary step-up gearbox 16 which increases rotational speed by a factor of about 20. The power from the gearbox 16 is used to drive a generator 20, shown in FIG. 2.

The generator 20 operates in a synchronous manner and so its output frequency is dependent on the speed at which it is driven. Consequently, between the gearbox 16 and the generator 20, is a speed control mechanism 18, including a motor/generator 30, described in more detail below.

FIG. 2 shows schematically the internal parts of the power generating apparatus 5 illustrated in FIG. 1. Input shaft 12 drives the planetary gearbox 16. The planetary gearbox drives a pinion 17, which in turn drives a spur gear 19. The spur gear 19 is connected to a speed control mechanism 18. This mechanism has an input 22 feeding power to the planetary carrier of a planetary differential transmission 24. The planetary differential has a planet carrier driven by the input 22, a sun gear 25 operatively connected to an electric machine 30, and a ring gear 23 operatively connected to generator 20. The power provided by the rotor can take two paths—all the power or a portion of it can flow directly to the generator 20 via output shaft 26 via ring gear 23, or some of the power can be taken via sun gear 25, and gear pairs 28 and 32, to the electric machine 30. The electric machine 30 is a switched reluctance motor which can operate as a motor or a generator.

In operation, the planetary transmission 24 will route power from input 22 to the path of least resistance and so the motor/generator 30 has to provide some reactive torque for the generation of power at generator 20. The amount of reactive torque can be varied considerably using the motor/generator 30. It will be noted that the gear pairs 28 and 32 will step-down the speed of the electric machine 30 and thus provide a greater reaction torque for a lower power machine 30. Thus a smaller machine 30 can be used to produce a relatively high reaction torque at the sun gear 25. However, the step down gearing has a relatively high inertia which will affect the reaction torque when changes in reaction torque are needed, for example to overcome sudden changes in input torque resulting from gusts or lulls in the wind.

In use, starting at light wind speed conditions, the rotor will turn faster than about 14 rpm. The motor/generator can be used as a motor to produce a reaction torque which causes a net positive increase in speed at the sun gear 25 of the planetary mechanism 24 so that all the power for input 22 can be fed to the generator. If the motor/generator 30 is providing such a torque then this will increase the speed of ring gear 23 so that the generator turns at the desired speed of 1512 rpm in this case.

As wind speed increases the speed of the motor can be reduced because the input 22 is now turning faster. At a rotor speed of about 17.3 rpm (in this instance) the input speed matches the generator input speed and so the reaction torque produced by the motor/generator is such that the motor speed is zero, although some reaction torque will be required at the sun gear 25.

At this low wind speed operating regime, even thought the motor/generator 30 is requiring electricity to operate, power is being generated by the apparatus 5 overall.

As wind speed increases to turn the rotor at a speed higher than about 17.3 rpm, then, to keep the output shaft 26 turning at the correct speed, power has to be fed away from the output shaft 26 and into the motor/generator 30. So the motor/generator 30 has to provide a slipping reaction torque. This can be achieved by using the motor/generator 30 as a generator of power. In this instance the amount of torque can be altered by varying the load on the motor/generator 30 and this load can be changed to maintain the speed of shaft 26.

When the rotor speed exceeds about 20 rpm clutch 42 can be disengaged to allow free rotation of the rotor. Alternatively a brake can be employed. Below about 14 rpm the whole machine does not operate.

FIG. 3 shows a graph of A-turbine power (torque x speed at the rotor), B-Generator power (power output overall), C-SR drive (power consumption/generation of the motor/generator 30), and D-SR rpm (the speed needed for the motor/generator 30 to maintain the correct output speed of shaft 26).

It can be seen that generator power is substantially constant over the mid range of the rotor speed and only a small portion of the gross power generated by the apparatus is needed for torque control.

In practice the wind rarely blows constantly and so the transmission will be varying it's operation constantly in response to changes in input torque cause by changes in wind speed. FIG. 4 illustrates the method of controlling the reactive torque produced by the motor/generator 30 when changes in wind speed occur. The input speed is monitored at step 100, for example the speed of the rotor can be measured. The generator load is set or measured, depending on the downstream control, at step 110. The reaction torque produced by the motor/generator 30 can be controlled according to the input speed and generator load input shaft, at step 120. Changes in the reaction torque allow the turbine to speed up when wind gusts occur, effectively turning excess wind energy into rotational energy of the turbine, and slow down when lulls in the wind occur by taking more energy from the turbine.

Wind induced dynamic effects are important because the inertia of the machine is significant, when the gearing of the system elements and the changes in input speed are taken into consideration. So the control method described in the paragraph immediately above is enhanced by further adjustment of the reaction torque at step 130. In that step, the dynamic torque loading of the input is measured. This is achieved by measuring the force exerted on a generally stationary reaction point in the speed increasing gearbox 16. The reaction torque produced by the motor/generator 30 is adjusted to take account of this varying dynamic input torque. For example where a sudden gust of wind takes place, the dynamic torque of the input will increase suddenly. The theoretical reaction torque which depends on input torque and generator load, can be set almost instantaneously, e.g. by setting the motor/generator to act as a generator and let the sun gear slip to take speed away from the generator 20. However, in practice, because of the inertia of the gears 28 and 32 and the inertia the motor/generator 30, any alteration in the set reaction torque would take time to have effect, and in the example sufficient slipping would take time to come about. To aid the process and prevent over-speed of the generator 20 the motor/generator 30 can be powered momentarily in the direction the slip of sun gear 25 so the effects of the inertia mentioned above are substantially negated.

The process of setting the reaction torque provided by the motor/generator is made almost instantaneous because a switched reluctance machine (SRM) is used.

Adjustment of torque provided by the SRM, by changing the current flowing in the appropriate coils of the machine, is made 360 times per revolution and torque is controlled effectively.

In operation the speed of the turbine is measured, the reaction to input torque at the gearbox is measured and so the turbine power can be determined. This enables the correct load on the generator can be applied. Knowing the turbine power allows the SRM reaction torque to be adjusted appropriately so the generator can be operated at the correct speed. Maintaining that correct generator speed is done effectively by measuring the dynamic input torque at a reaction point in the gearbox and using a SRM to effect reaction torque changes almost instantaneously. The SRM's angular position is monitored and the correct switching of current to the coils of the SRM can be provided to enable the correct reaction torque.

One embodiment only has been described but various alternatives, adaptations, modifications etc will be apparent to the skilled addressee. In particular the arrangement of the gears could be changed to provide the equivalent effect to that described. The machine described is a wind turbine but the same principle applies to and fluid flow driven machine e.g. a tidal flow water turbine.

1. A rotatable drive mechanism for driving an electrical generator, which mechanism provides a substantially constant speed rotational output for driving the generator from a variable speed rotatable input, the mechanism including a variable speed input, geared differential transmission for receiving power from the variable speed input, the differential transmission having two power sharing paths, a first of the paths in rotational communication with an output for driving the generator and a second of the paths in rotational communication with an electric machine operable to provide a variable reaction torque in the second path, the mechanism including a torque monitor for monitoring dynamic torque at the input and a controller for altering the reaction torque in the second path in response to changes in the monitored torque, by means of operating the electric machine as a motor or a generator, and thereby permitting the substantially constant speed rotation of the output, characterised in that the monitor monitors the dynamic torque at the input and the controller operates the electric machine to negate at least some of the inertia of the electric machine and/or of the second of the paths.

2. A rotatable drive mechanism as claimed in claim 1 wherein the input includes a shaft and a step-up gearbox for increasing the rotational speed delivered to the geared transmission.

3. A rotatable drive mechanism as claimed in claim 2 wherein said dynamic torque monitor monitors the substantially stationary reaction torque of the step-up gearbox.

4. A rotatable drive mechanism as claimed in claim 1 wherein said differential transmission comprises a planetary gear arrangement having a planet gear carrier for being driven by the input, a sun wheel which forms part of the first power path and a ring gear which forms part of the second power path.

5. A rotatable drive mechanism as claimed in claim 1 wherein, when the input speed is below a predetermined value the electric machine is operable as a motor and provides a variable reaction torque in the second path such that a driving torque is provided to the gear transmission via the second power path and in so doing maintains the rotational speed of the first power path substantially at a predetermined speed.

6. A rotatable drive mechanism as claimed in claim 1 wherein, when the input speed is above the predetermined value the electric machine operable as a generator and provides a further variable reaction torque and accepts power from the gear transmission via the second power path and in so doing maintains the rotational speed of the first power path substantially at the predetermined speed.

7. A rotatable drive mechanism as claimed in claim 1 wherein the second power path includes a further gearing for changing the rotational speed of the second power path.

8. A rotatable drive mechanism as claimed in claim 1 wherein the first or second power path includes a clutch or brake for disengaging or braking the respective path when rotation of the is rotor is inhibited but the generator is still in motion.

9. A rotatable drive mechanism as claimed in claim 1 wherein the electric machine is a switched reluctance machine (SRM).

10. A rotatable drive mechanism as claimed in claim 9 wherein, the angular position of the SRM is used, in part, to control the reaction torque.

11. A method of controlling the rotational speed of a generator drive mechanism to provide a substantially constant rotational speed for the generator resulting from a variable speed input, the method employing a mechanism which provides a substantially constant speed rotational output for driving the generator from a variable torque rotatable input, the mechanism including a variable speed input, geared differential transmission for receiving power from the variable torque input, the differential transmission having two power sharing paths, a first of the paths in rotational communication with an output for driving the generator and a second of the paths in rotational communication with an electric machine operable to provide a variable reaction torque in the second path, the method including the following steps, to be performed in any suitable order, of: a) monitoring the dynamic torque of the input; b) controlling the reaction torque in the second path in response to the monitored dynamic input torque, by means of operating the electric machine as a motor or a generator, and thereby permitting the substantially constant speed rotation of the output; and the method being characterised by the step of: c) operating the electric machine to substantially negate the effects of inertia in the second path and/or in the electric machine.

12. A method as claimed in claim 11 wherein the monitored dynamic input torque is the reaction torque of the geared differential transmission.

13. A method as claimed in claim 11 including the further steps of: d) in addition to step a), measuring the input speed and generator load; and e) controlling the reaction torque in the second path in response to the input speed and generator load, as well as in response to the monitored input torque, by means of operating the electric machine as a motor or a generator.

14. A method as claimed in claim 13 including the further steps of: f) operating the electric machine as a motor, at a first predetermined input speed range; and g) operating the electric machine as a generator at a second predetermined input speed range which second range is higher than the first range.

15. A rotatable drive mechanism for driving an electrical generator, which mechanism provides a substantially constant speed rotational output for driving the generator from a variable speed rotatable input, the mechanism including a variable speed input, geared differential transmission for receiving power from the variable speed input, the differential transmission having two power sharing paths, a first of the paths in rotational communication with an output for driving the generator and a second of the paths in rotational communication with an electric machine operable to provide a variable reaction torque in the second path, the mechanism including a torque monitor for monitoring dynamic torque at the input and a controller for altering the reaction torque in the second path in response to changes in the monitored torque, by means of operating the electric machine as a motor or a generator, and thereby permitting the substantially constant speed rotation of the output, characterised in that the dynamic input torque is monitored by means of measuring the stationary reaction torque of the geared differential transmission.

16. A wind or water driven turbine, having a rotatable drive mechanism as claimed in claim 1.

17. A wind or water driven turbine including a variable speed wind or water drivable rotor, a generator, and a differential gearbox providing rotary communication between the rotor and the generator, the generator being drivable, via the gearbox, at substantially constant speed by the variable speed rotor, the gearbox providing a variable torque reacting against the rotor torque for allowing said substantially constant generator speed and for allowing said rotor to increase or decrease in speed with increased or decreased wind or water speed characterised in that the dynamic input torque applied to the gearbox by the rotor at a reaction point of the gearbox is measured to provide said variable torque reacting against the rotor.

18. A wind or water turbine as claimed in claim 17 wherein the variable reaction torque is providable by a further generator having further rotary communication with the gearbox, the further generator being operable as a further generator or as a motor, and being further operable to substantially negate its own inertia and/or the inertia of said further rotary communication.

19. A wind or water turbine as claimed in claim 18 wherein the further generator is a switched reluctance machine.

20. A wind or water driven turbine, having a drive mechanism operable according to the method of claim 11.
